(19) United States
(12) Patent Application Publication
(10) Pub. No.: US 2014/0355272 A1
(43) Pub. Date: Dec. 4, 2014

(54) LED Lighting Assembly and Method of Forming LED Lighting Assemblies for Retrofit into Flourescent Housing Fixtures

(71) Applicant: Enertron, Inc., Gilbert, AZ (US)

(72) Inventor: Der Jeou Chou, Mesa, AZ (US)

(21) Appl. No.: 13/906,263

(22) Filed: May 30, 2013

(51) Int. Cl. F21S 4/00; F21S 8/04

(52) U.S. Cl. CPC F21S 4/008; F21S 8/04
USPC 362/308; 29/592.1

(57) ABSTRACT

A lighting assembly has a light strip and a first reflector. The light strip includes a base with a ridged wall, a light engine with a plurality of LEDs disposed over the base, and a lens disposed over the light engine. The first reflector has an opening and a tab adjacent to the opening. The light strip is disposed over the first reflector with the ridged wall disposed through the opening in the first reflector. The tab is disposed over the ridged wall to secure the light strip to the first reflector. A power supply is disposed over the reflector and electrically coupled to the light strip. The base of the light strip includes a thermally conductive material. The lens is formed with a light-diffusing material. The first reflector has a stepped mounting portion. A housing fixture is disposed over the lighting assembly.

### FIELD OF THE INVENTION

The present invention relates in general to lighting products and, more particularly, to a light-emitting diode (LED) lighting assembly and method of forming LED lighting assemblies capable of retrofit into fluorescent housing fixtures.

### BACKGROUND OF THE INVENTION

Today most commercial buildings use fluorescent lighting, consisting of linear (or tubular) fluorescent lamps housed within a troffer or surface mounted fixture. While more efficient than incandescent lamps, linear fluorescent lamps have disadvantages.

There are a number of negative health effects that have been linked to working under fluorescent lighting, e.g., migraines, eyestrain, problems sleeping due to melatonin suppression, symptoms of Seasonal Affective Disorder or depression, stress or anxiety due to cortisol suppression, and Agoraphobia. Fluorescent lamps also contain mercury and must be disposed of according to EPA guidelines regarding hazardous waste. Some fluorescent lamps have a green cast, which can make the environment a fluorescent lamp is lighting look drab. Additionally, fluorescent lamps do not have an instant turn-on and require time to “warm up” before producing full light.

Another problem with fluorescent lighting is an inherent flickering of the light emitted from fluorescent lamps. A fluorescent lamp emits light by sending pulses of electricity, produced by a ballast, through a phosphor coated glass tube containing mercury vapor. The pulses of electricity excite the mercury, which then produces short-wave ultraviolet light. The short-wave ultraviolet light causes the phosphor coating to fluoresce, producing visible light. The rate of the pulses of electricity sent by the ballast is normally so high that the inherent flickering of the emitted light is negligible and the light looks constant. However, there are some people who perceive the inherent flickering of the emitted light. The people who perceive the flickering will often times suffer from headaches, migraines, eye strain, and eye discomfort. Additionally, as ballasts and fluorescent lamps age, the light emitted from the fluorescent lamp is more prone to produce a noticeable flicker, necessitating the replacement of old lamps and ballasts. A buzzing noise may also be produced by a bad or old ballast that needs replacing. Finally, the constant on/off, i.e., inherent flickering, of a fluorescent lamp reduces the operating life of the fluorescent lamp dramatically.

Energy use in commercial buildings and manufacturing plants accounts for nearly half of all energy consumption in the U.S. at a cost of over $200 billion per year, more than any other sector of the economy. Commercial and industrial facilities are also responsible for nearly half of U.S. greenhouse gas emissions which contribute to climate change. The term “Energy Star” refers to the U.S. government's energy performance rating system program that is jointly managed by the U.S. Department of Energy (DOE) and the U.S. Environmental Protection Agency (EPA). According to Energy Star guidelines, to qualify for the Energy Star label, a commercial building must achieve a score of 75 or above on the EPA's energy performance scale, indicating that the building performs better than at least 75% of similar buildings nationwide.

Replacing traditional fluorescent lighting products, such as the linear fluorescent lamp, with a corresponding LED lighting assembly can bring down energy consumption, increase luminance, and decrease pollution. To integrate into the fluorescent lighting market an LED lighting assembly must not impose unnecessary burdens on suppliers or require the redesign of the established or existing housing fixtures.

### SUMMARY OF THE INVENTION

A need exists for an LED lighting assembly with maximum luminous efficacy that is cost efficient to manufacture and ship, capable of effective light distribution and heat dissipation, and easily assembled and retrofitted in existing and new troffer or surface mounted fixtures. Accordingly, in one embodiment, the present invention is a method of making a lighting assembly comprising the steps of providing a light strip by forming a base including a ridged wall, disposing a light engine including a plurality of LEDs over the base, and disposing a lens over the light engine. The method further includes the steps of providing a first reflector including an opening and a tab adjacent to the opening, disposing the light strip over the first reflector including the ridged wall disposed through the opening, disposing the tab over the ridged wall to secure the light strip to the first reflector, and disposing a power supply over the first reflector electrically coupled to the light strip.

In another embodiment, the present invention is a method of making a lighting assembly comprising the steps of forming a base including a wall extending vertically from a base plate, disposing a light engine including a plurality of LEDs over the base, disposing a lens over the light engine, providing a first reflector including an opening, and disposing the base over the first reflector including the wall disposed through the opening.

In another embodiment, the present invention is a lighting assembly comprising a light strip including a base, a plurality of LEDs disposed over the base, and a lens disposed over the LEDs. A first reflector including an opening is disposed over the light strip with a portion of the base of the light strip disposed through the opening.

In another embodiment, the present invention is a lighting assembly comprising a first reflector and a light strip disposed over the first reflector and extending through an opening of the first reflector.

### BRIEF DESCRIPTION OF THE DRAWINGS

FIG. 1 illustrates an exploded view of a light strip;

FIG. 2 illustrates further detail of a light engine of the light strip of FIG. 1;

FIG. 3 illustrates a cross-sectional view of a base of the light strip of FIG. 1;

FIGS. 4a-4c illustrate a method of making an LED lighting assembly;

FIGS. 5a-5c illustrate retrofitting the LED lighting assembly of FIG. 4c into a housing fixture;

FIGS. 6a-6b illustrate an alternate embodiment of an LED lighting assembly;

FIGS. 7a-7b illustrate retrofitting the LED lighting assembly of FIG. 6b into a housing fixture; and

FIGS. 8a-8b illustrate a method of making a retrofit LED lighting assembly which provides indirect lighting.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, one skilled in the art will appreciate that the description is intended to cover alternatives, modifications, and equivalents as may be included within the spirit and scope of the invention as defined by the appended claims and the equivalents as supported by the following disclosure and drawings.

LEDs have been used for decades in applications requiring relatively low-energy. In recent years, however, the brightness and power of individual LEDs have increased substantially, resulting in the availability of LED packages ranging from 0.1 watt up to 100 watt and suitable for use in larger scale lighting applications.

While small, LEDs exhibit a high efficacy and life expectancy as compared to traditional lighting products. A typical incandescent bulb has an efficacy of 10 to 12 lumens per watt and lasts for about 1,000 to 2,000 hours; a general fluorescent bulb has an efficacy of 40 to 80 lumens per watt and lasts for 10,000 to 20,000 hours; a typical halogen bulb has an efficacy of 15 lumens per watt and lasts for 2,000 to 3,000 hours. In contrast, today's white LEDs can emit more than 120 lumens per watt with a life expectancy of about 100,000 hours.

LED lighting sources provide a brilliant light, sufficient to illuminate an area in home, office, or commercial settings. LED lighting is efficient, long lasting, cost-effective, and environmentally friendly. LEDs emit light in a specific direction and light an area more efficiently than lamps that produce omni-directional light, which is wasted into a ceiling or other area that does not need lighting. LEDs are also dimmable, come in a variety of color options, and have an instant turn-on, i.e., LEDs do not need a warm-up time which halogen and fluorescent lamps require. Unlike a fluorescent lamp, an LED light source emits a constant, non-flickering light and can be turned on and off millions of times at a very high speed with no degradation in the operating life of the LED light source. For the above reasons, LED lighting is rapidly becoming the light source of choice in many applications.

LED lighting relies on light engines to generate the light energy emitted from an LED light source. A light engine consists of a plurality of individual LED devices electrically interconnected over a substrate. A power supply energizes the LED devices via connection terminals on the substrate and the energized LEDs produce light.

An important design aspect of LED lighting is the need for efficient heat dissipation. Excessive heat minimizes the lifespan of an LED light source as well as reduces the luminous efficacy. In some cases, excessive heat also modifies the operating characteristics of the LED light source. For example, because the light generation properties of many LED light sources are at least partially governed by temperature, a significant change in the ambient temperature surrounding an LED light source can cause a change in the correlated color temperature (CCT) of white light emitted from the LED light source. Accordingly, a thermally efficient LED light engine minimizes CCT shift and prolongs the lifespan of an LED light source.

Fluorescent lighting is one of the most common types of commercial lighting. Retrofitting a lighting assembly including an LED light source into existing troffer or surface mounted fixtures brings down energy consumption, increases luminance, and decreases pollution. To replace linear fluorescent lamps with an LED lighting assembly, an LED lighting assembly must address the heat dissipation requirement of an LED light source without unnecessarily restricting entry into the market to total custom solutions. In other words, the commercial lighting market exists with many standard housing fixtures, e.g., the troffer or surface mounted fixture; to integrate into the fluorescent lighting market an LED lighting assembly must not impose unnecessary burdens on suppliers or necessitate the redesign of existing housing fixtures.

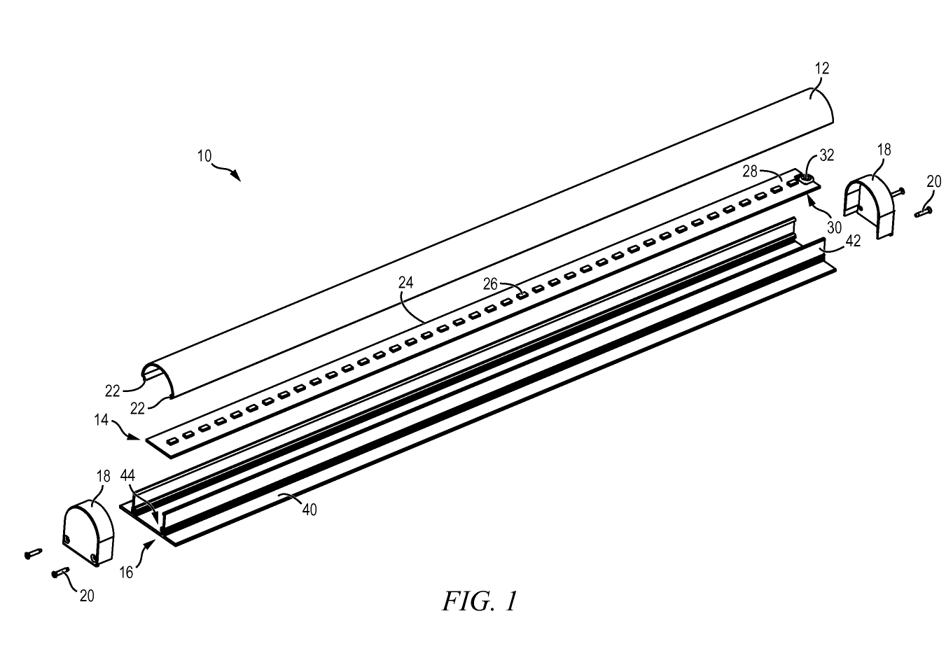

FIG. 1 shows an exploded view of a light strip 10. Light strip 10 includes a lens 12, a light engine 14, a light strip base 16, end caps 18, and end cap screws 20. Light engine 14 generates the light emitted from light strip 10. Light engine 14 includes a substrate or printed circuit board (PCB) 24 and a plurality of LEDs 26 mechanically connected to substrate 24.

Substrate 24 provides structural support for LED devices 26. Substrate 24 includes a first surface 28 and a second surface 30. Second surface 30 is opposite first surface 28. First surface 28 is oriented toward lens 12. An electrical lead hole 32 is formed through substrate 24. Electrical lead hole 32 extends from first surface 28 of substrate 24 to second surface 30.

Substrate 24 dissipates the heat generated by LED devices 26. Substrate 24 is a fire retardant 4 printed circuit board (FR4 PCB) or other structure having good thermal conduction properties. FR4 PCB is a substrate that contains electronic circuitry, is cost-effective, and has a thermal conductivity greater than 0.25 W/° K-m. An FR4 PCB substrate 24 satisfies the thermal requirements of LED light engine 14 and lowers manufacturing costs. Copper foil is laminated on surface 28 and/or surface 30 of substrate 24 and acts as a heat spreader for substrate 24. Lower power LED devices, e.g., <0.3 watt, are mounted on surface 28. Alternatively, substrate 24 is an MCPCB. MCPCB has a thermal conductivity greater than 1.0 W/° K-m. MCPCBs are capable of supporting higher power LED devices, e.g., >0.5 watt. MCPCBs are fabricated using conventional FR4 PCB and are also relatively inexpensive to make. Other suitable substrates include various hybrid ceramics substrates and porcelain enamel metal substrates. White masking is applied on surface 28 and the circuitry of substrate 24 is plated with silver, nickel, or tin to enhance the light reflection from substrate 24. An additional fluorescent or phosphorous material is deposited over a surface of substrate 24 or formed within substrate 24 to further emphasize the light output of light engine 14, promote even light spreading, and allow portions of substrate 24 to fluoresce. The fluorescent or phosphorous material absorbs photons generated by LEDs 26 and emits additional photons having a particular range of wavelengths. The fluorescent or phosphorous material promotes light output and light spreading by adjusting the wavelength of the emitted light.

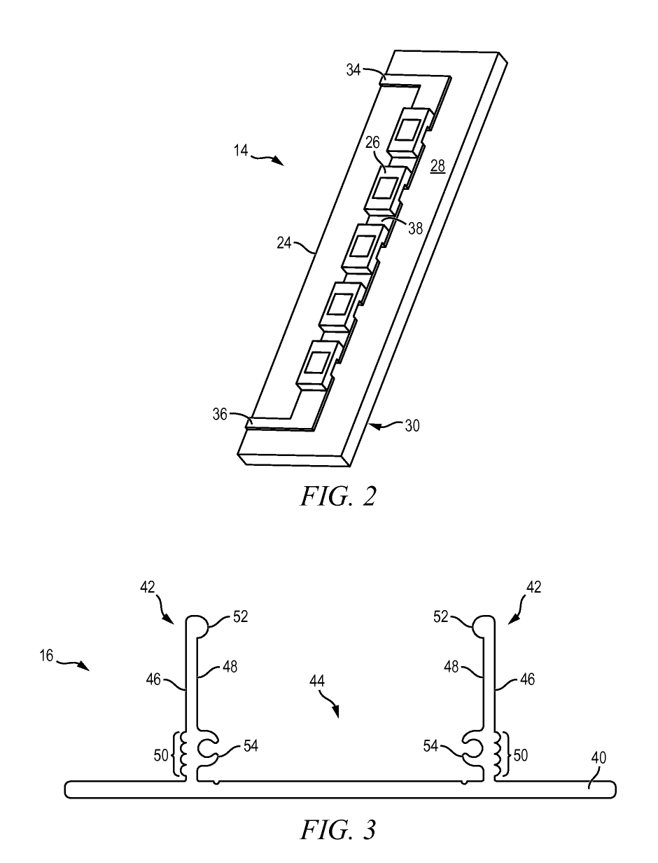

FIG. 2 shows the connectivity of light engine 14. LEDs 26 are surface mounted to first surface 28 of substrate 24. LEDs 26 are manufactured using one or more suitable semiconductor materials, including, for example, GaAsP, GaP, AlGaAs, AlGaInP, GaInN, or the like. A direct current (DC) voltage is applied across terminals 34 and 36. The DC voltage is routed through metal conductors or trace patterns 38 to supply operating potential to LEDs 26. LEDs 26 can also be interconnected with wire bonds or solder bonds. LEDs 26 are connected in electrical parallel configuration or electrical series configuration or a combination thereof. FIG. 2 illustrates five LED semiconductor devices 26 in a series. LEDs 26 can be laid out in multiple regions, where each of the regions exhibits different patterns and numbers of devices.

Referring back to FIG. 1, light engine 14 is disposed over light strip base 16. Second surface 30 of substrate 24 is oriented toward light strip base 16. Light engine 14 is secured to base 16 by applying an attach adhesive, such as adhesive film, thermal grease, thermal interface pad, phase change pad, or other suitable thermally conductive adhesive between second surface 30 and light strip base 16. The heat generated by LED devices 26 is transferred from substrate 24 to base 16.

Light strip base 16 includes a base plate 40, walls 42, and a substrate attach site 44. Light strip base 16 is formed by extrusion, stamping, die-casting, molding, or other suitable manufacturing process. Light strip base 16 includes a thermally conductive material such as aluminum, aluminum alloys, copper, copper alloy, thermally conductive plastic, or thermally conductive carbon fiber composite material. Light strip base 16 facilitates dissipation of the heat produced by light engine 14.

FIG. 3 illustrates a cross-sectional view of light strip base 16. Light strip base 16 includes base plate 40 and walls 42. Walls 42 extend vertically from base plate 40. Walls 42 form a substrate attach site 44 on base plate 40. Substrate attach site 44 serves as a mounting site for light engine 14.

Each wall 42 includes a first surface 46 and a second surface 48 opposite first surface 46. First surface 46 is oriented away from substrate attach site 44 and second surface 48 is oriented toward substrate attach site 44. A ridged portion 50 is formed over an area of first surface 46. Ridged portion 50 is formed adjacent to base plate 40. Ridged portion 50 extends the entire length of wall 42. Ridged portion 50 creates areas of differing width over surface 46 such that a width of wall 42 near a base of a ridge is less than a width of wall 42 near a height of the ridge. Ridged portion 50 creates additional surface area on light strip base 16 from which heat generated by light engine 14 is dissipated. Ridged portion 50 also serves as an engaging guide or attachment mechanism and facilitates the securement of light strip 10 to a reflector.

A lens attach lip 52 is formed over an area of second surface 48 distal to base plate 40. Lip 52 is a convex curve and runs the length of wall 42. Lip 52 assists in attaching lens 12 to wall 42 by friction coupling to lens 12. An end cap screw receptacle 54 is formed on second surface 48 between lens attach lip 52 and base plate 40. End cap screw receptacle 54 receives end cap screw 20 and secures end cap 18 to light strip base 16.

Referring back to FIG. 1, lens 12 is disposed over light engine 14 and light strip base 16. Lens 12 disperses the light produced by light engine 14. Lens 12 is made by injection molding, extrusion, or other suitable manufacturing technique. Lens 12 includes a substantially transparent material such as plastic, glass, or polycarbonate. The polycarbonate, plastic, or glass material of lens 12 is mixed with a diffusion agent prior to forming lens 12 to increase the diffusivity of lens 12. In one embodiment, the diffusivity of lens 12 is adjusted by coating a surface of lens 12 with one or more light-diffusing materials. The coating on lens 12 diffuses the light emitted by LEDs 26 into a relatively smooth light.

Lens 12 has a semi-cylindrical shape and a length approximately equal to the length of light strip base 16. Lens 12 includes base attach curves 22. Base attach curve 22 is formed at the distal end of each lateral side of lens 12. Base attach curve 22 is a concave curve and runs the length of lens 12. Curve 22 opens toward lens attach lip 52 of light strip base 16. Curves 22 facilitate the attachment of lens 12 to light strip base 16 by friction and expansion coupling to lens attach lips 52.

End caps 18 are placed on each end of light strip 10. End caps 18 slide over lens 12 and first surface 46 of wall 42. End cap screws 20 are inserted through screw holes in end caps 18 and married to end cap screw receptacles 54 in light strip base 16.

The diffusivity of lens 12, the number of LEDs 26 on substrate 24, the beam spray angle of LED 26, and the distance between lens 12 and LEDs 26 are selected to optimize even light spreading and regulate the brightness or “amount” of light emitted from light strip 10. The diffusivity of lens 12 is defined by the percentage of emitted light that passes through lens 12 without being absorbed by lens 12. The number of LEDs 26 on substrate 24 is defined by the pitch distance between LEDs 26. The beam spray angle of LED 26 is defined by the angle of the width of light emitted from LED 26. The distance between lens 12 and LEDs 26 is defined by the height of walls 42. The amount of light emitted by a light strip is defined by the luminous flux. Luminous flux is the amount of visible light produced by the assembled light strip.

TABLE 1
Luminous Flux of LED Light Strip

| | | | | Luminous |
|---|---|---|---|---|
| LED Pitch | Beam Spray | Wall Height | Lens | Flux |
| (mm) | (degrees) | (mm) | Diffusivity | (lumen) |
| 12.5 | 120 | 5 | 80% | 1187 |
| 12.5 | 120 | 10 | 80% | 1161 |
| 12.5 | 120 | 5 | 75% | 1118 |
| 12.5 | 120 | 10 | 75% | 1113 |
| 12.5 | 120 | 5 | 67% | 994 |
| 12.5 | 120 | 10 | 67% | 977 |

As shown in Table 1, an LED pitch distance of 12.5 mm, a beam spray of 120°, a base wall height of 5 mm, and a lens diffusivity of 80% will produce a light strip with a luminous flux of 1187 lumen; an LED pitch distance of 12.5 mm, a beam spray of 120°, a base wall height of 10 mm, and a lens diffusivity of 80% will produce a light strip with a luminous flux of 1161 lumen. The diffusivity of lens 12, the pitch distance between LEDs 26, and the distance between lens 12 and LEDs 26 selected produce a light strip 10 with excellent luminous efficacy that mimics the light spreading properties of a fluorescent lamp. Luminous efficacy is defined by the ratio of the luminous flux to the input power.

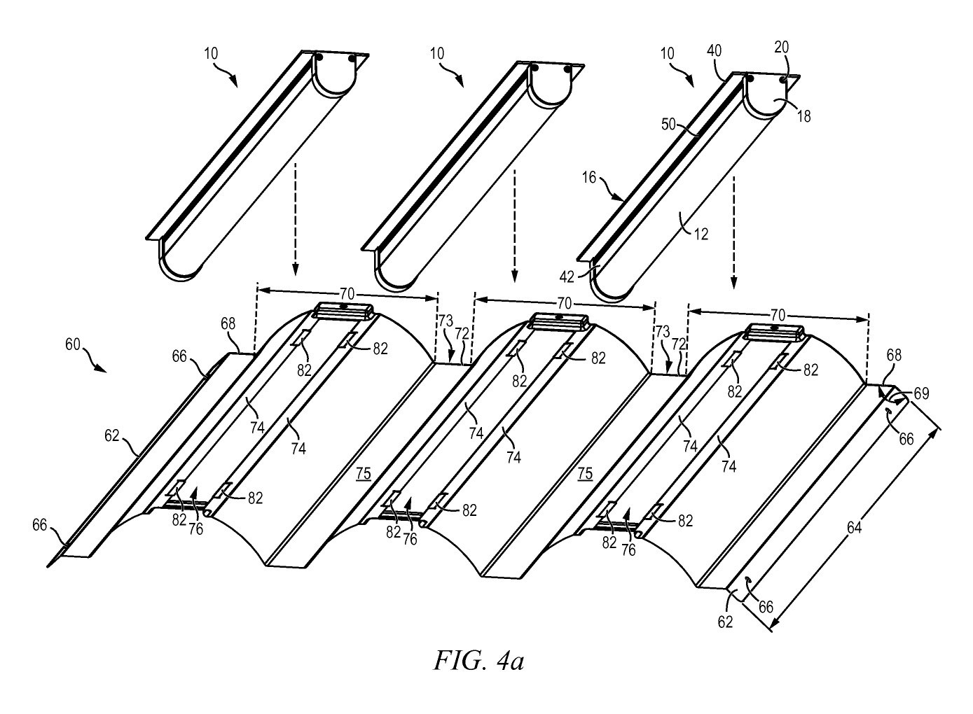

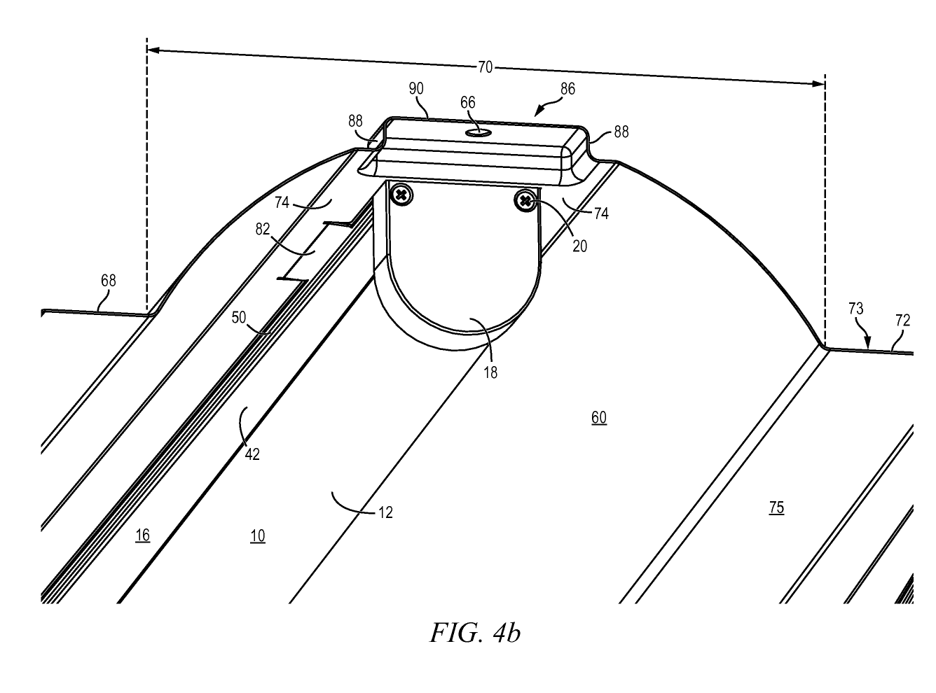

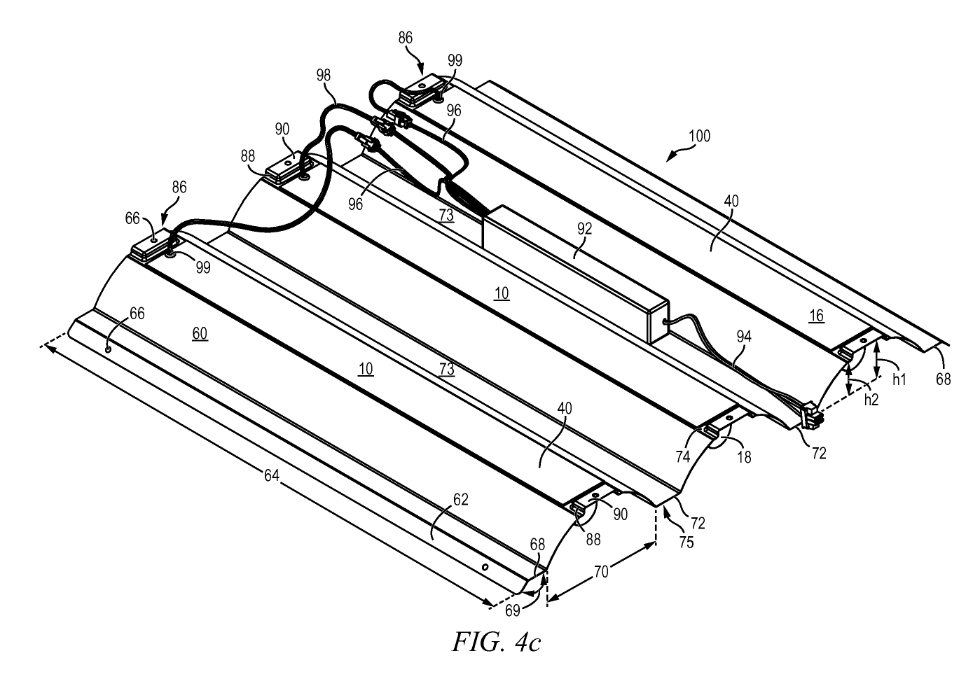

FIGS. 4a-4c illustrate a method of making an LED lighting assembly. FIG. 4a illustrates three assembled light strips 10 from FIG. 1 disposed over a reflector 60.

Reflector 60 includes a thermally conductive material such as aluminum, aluminum alloys, copper, thermally conductive plastics, thermally conductive carbon fiber composites material, or steel. Reflector 60 is formed by stamping, roll forming, die-casting, extrusion, or other suitable manufacturing process. Reflector 60 assists in directing the light emitted from light strip 10. Reflector 60 includes a polished, mirror-like surface for reflecting or focusing light emitted by light strips 10.

A flange 62 is formed on each of the distal ends of reflector 60. Flange 62 extends the length 64 of reflector 60. Flange 62 includes two mounting screw holes 66. Flange 62 connects to a flat portion 68 at an angle 69. Flat portion 68 is planar and extends from flange 62 to a riser portion 70. Riser portion 70 has a semi-cylindrical shape and extends in a direction opposite flange 62. Adjacent riser portions 70 are connected by a flat portion 72. Flat portion 72 is on the same plane as flat portion 68. Flat portion 72 is planar and includes a first surface 73 and a second surface 75 opposite first surface 73. Flat portions 68, riser portions 70, and flat portions 72 extend the entire length 64 of reflector 60. In one embodiment, riser portions are trapezoidal in shape rather than semi-cylindrical such that the vertical sections of riser portions 70 are straight rather than curved. The height of riser portions 70 is adjusted and flat portions 68 and flat portions 72 are eliminated from reflector 60 to accommodate a housing fixture of shallow depth and decrease the overall height of reflector 60. Riser portions 70 connect directly to flanges 62 and adjacent riser portions 70 to eliminate flat portions 68 and flat portions 72.

A light strip attach portion 74 is formed at the height of each riser portion 70. Light strip attach portion 74 is rectangular in shape. An opening 76 is formed within light strip attach portion 74. Opening 76 is rectangular in shape and has a footprint larger than the footprint of end caps 18, lens 12, and walls 42 of light strip 10. The footprint of opening 76 is smaller than the footprint of base plate 40. The footprint of opening 76 allows walls 42, lens 12, and end caps 18, but not base plate 40 to extend through opening 76. Light strip attach portion 74 is configured to support base plate 40. Light strip securing tabs 82 are formed in light strip attach portion 74. Tabs 82 are adjacent to opening 76. Tabs 82 bend and engage ridged portion 50 of base 16 and secure LED light strip 10 to reflector 60.

FIG. 4b shows the completed mechanical assembly of light strip 10 disposed over and attached to reflector 60. Lens 12, walls 42, and end caps 18 are disposed through opening 76 in reflector 60. Base plate 40 of light strip base 16 is resting against light strip attach portion 74. Light strip securing tabs 82 are disposed over and engage ridged portion 50 on walls 42. Tabs 82 secure light strip 10 to reflector 60. A thermally conductive material such as thermal grease, a thermally conductive pad, or a thermal epoxy is deposited between base plate 40 of light strip 10 and light strip attach portion 74 to enhance the thermal connection between light strip 10 and reflector 60. Heat from substrate 24 is transferred from base 16 to reflector 60. Reflector 60 provides additional surface area for dissipating heat generated by light engine 14.

Reflector 60 includes a stepped mounting portion 86 formed on each end of light strip attach portion 74. Stepped mounting portion 86 includes riser portions 88 and a plateau portion 90. Riser portions 88 extend vertically from light strip attach portion 74. Plateau portion 90 connects riser portions 88 and includes a mounting screw hole 66. Plateau portion 90 is approximately parallel to light strip attach portion 74.

FIG. 4c shows a plan view of an LED lighting assembly 100. LED lighting assembly 100 includes reflector 60, light strips 10, and a power supply 92. Power supply 92 is disposed over first surface 73 of flat portion 72. Power supply 92 is electrically coupled to light strips 10.

Power supply 92 receives alternating current (AC) or DC energy via an electrical input 94 and supplies DC energy to LED light strip 10 via a connector 96. Electrical input 94 is configured to electrically couple power supply 92 to an electricity source. Power supply 92 modifies the energy received from electrical input 94 before delivering the DC energy to light strip 10. Power supply 92 contains power conversion circuitry to convert an AC input voltage from electrical input 94 to a DC output voltage. Power supply 92 contains power conversion circuitry to convert a DC input of a first voltage from electrical input 94 to a DC output of a second voltage. Power supply 92 includes any voltage step-up or step-down circuitry necessary for supplying a correct DC output voltage to light strip 10. Power supply 92 can be implemented using a pulse with modulated (PWM) power supply. The DC output voltage from power supply 92 is routed to light strip 10 by connector 96. Connector 96 is configured to electrically couple power supply 92 to an electrical lead 98 attached to light strip 10. Electrical lead 98 extends through an electrical lead hole 99 formed through base plate 40. Electrical lead 98 is electrically coupled to light engine 14 of light strip 10. Electrical lead 98 carries the DC voltage from connector 96 to light engine 14.

As shown in FIG. 4c, the length of riser portions 88 is greater than the height of base plate 40 such that the height, h₁, of plateau portion 90 is greater than the height, h₂, of light strip 10 attached to reflector 60. The difference in height of h₁ and h₂ creates space for electrical leads 98 and connectors 96 and prevents any mechanical interference between base plate 40 and any uneven or protruding portions of a housing fixture ceiling.

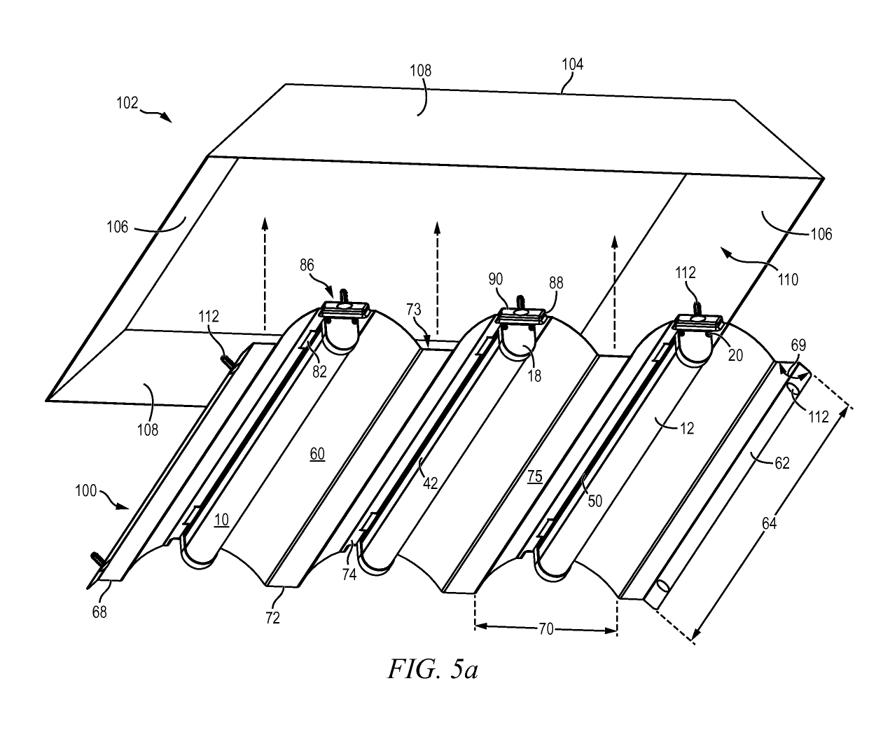

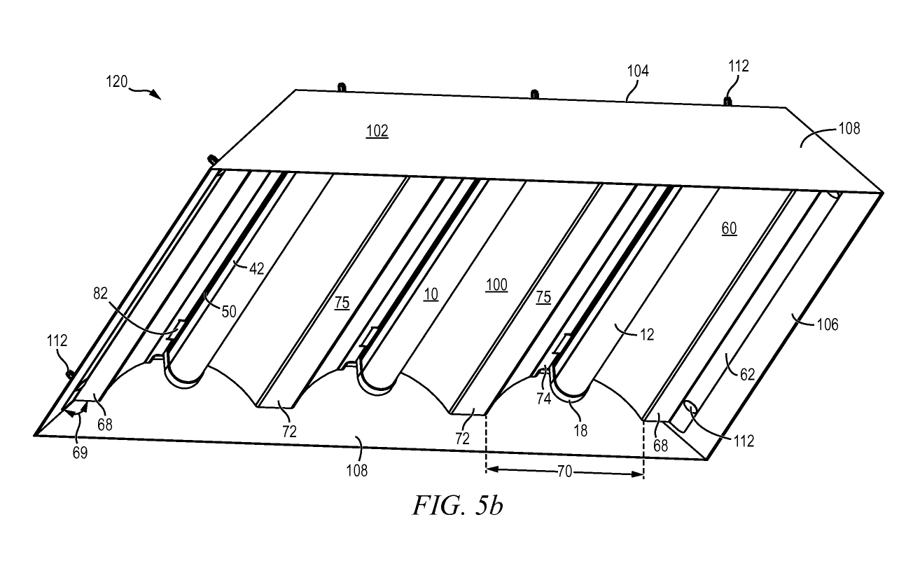

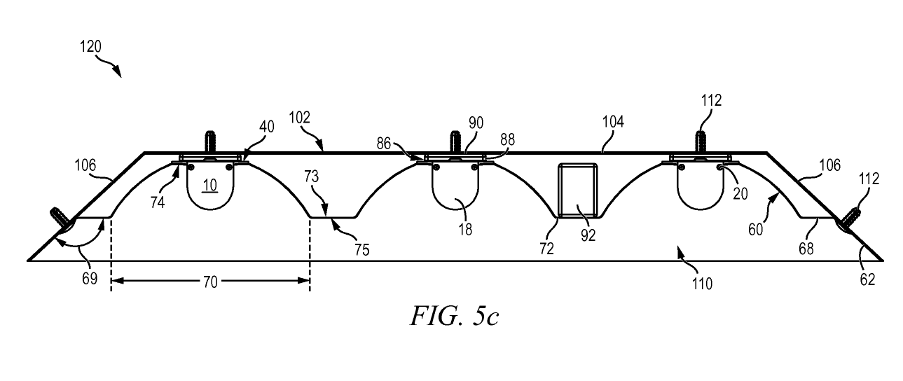

FIG. 5a illustrates retrofitting LED lighting assembly 100 from FIG. 4c into a fluorescent lighting housing fixture 102. Housing 102 represents any housing fixture capable of receiving lighting assembly 100, e.g., a troffer or surface mounted fixture. Housing 102 includes ceiling portion 104, sidewalls 106, and lateral walls 108. Ceiling portion 104, sidewalls 106, and lateral walls 108 form cavity 110. Self-tapping screws 112 are disposed through screw holes 66 in flanges 62 and stepped mounting portions 86 of reflector 60.

FIG. 5b shows lighting assembly 100 disposed within cavity 110. Screws 112 secure LED lighting assembly 100 to housing 102. The length 64 of reflector 60 is approximately equal to the length of sidewalls 106. Thus, there is no space between reflector 60 and lateral walls 108 of housing 102. Flat portions 68 and flat portions 72 are approximately parallel to ceiling portion 104. Angle 69, between flanges 62 and flat portion 68 of reflector 60, is adjusted such that flanges 62 rest against sidewalls 106. Additionally, the number of riser portions 70 and the number of openings 76 in reflector 60 is selected according to the parameters of housing 102 and the brightness, i.e., number of light strips 10, desired. In one embodiment, flat portions 68 and flat portions 72 are eliminated from reflector 60 and riser portions 70 connect directly to adjacent riser portions 70 and flanges 62. The elimination of flat portions 68 and flat portions 72 decreases the overall height of lighting assembly 100 and accommodates a housing 102 with a shallow cavity 110 depth. Lighting assembly 100 disposed in housing 102 forms retrofitted LED lighting assembly 120.

FIG. 5c shows a cross-sectional view of retrofitted LED lighting assembly 120. Self-tapping screws 112 secure flanges 62 to sidewalls 106 and stepped mounting portions 86 to ceiling portion 104. Power supply 92 is disposed between adjacent riser portions 70 and flat portion 72 of reflector 60 and ceiling portion 104 of housing 102. Stepped mounting portion 86 creates a space between base plate 40 of light strip 10 and ceiling portion 104. The space between base plate 40 and ceiling portion 104 accommodates electrical leads 98 and connectors 96. Ceiling portion 104 can include random protrusions extending into cavity 110. The space created by stepped mounting portion 86 also prevents mechanical interference between any random protrusions in ceiling 104 and base plate 40.

In one embodiment, housing 102 includes an optional lens cover or cross buffers. The lens cover or cross buffer is attached over LED lighting assembly 100 opposite ceiling portion 104. The lens cover or cross buffer is attached at the bottom of cavity 110. The lens cover or cross buffer is attached flush with the bottom of sidewalls 106 and lateral walls 108. The lens cover or cross buffer further aids in distributing light from light strips 10.

Retrofitted LED lighting assembly 120 provides a bright, energy efficient light source with maximum luminous efficacy. Reflector 60 and lens 12 disperse the light emitted from light strip 10 to provide a smooth, even light suitable for lighting an area in home, office, or commercial settings. Light strip base 16 and reflector 60 dissipate the heat generated by LEDs 26 prolonging the operating life and minimizing CCT shift of light engine 14.

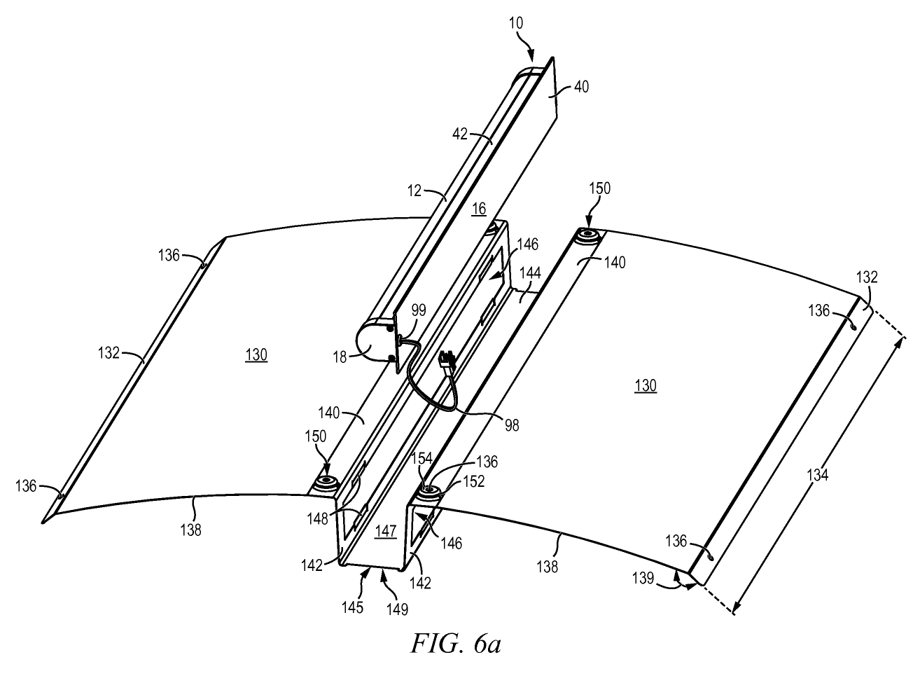

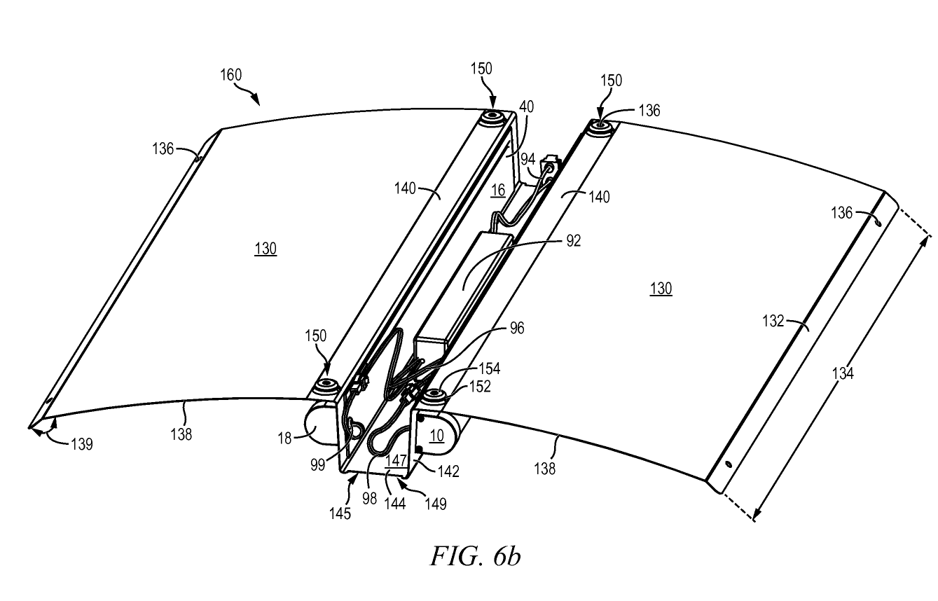

Another embodiment of an LED lighting assembly is shown in FIGS. 6a-6b. FIG. 6a shows light strip 10 from FIG. 1 disposed over a reflector 130. Reflector 130 includes a thermally conductive material such as aluminum, aluminum alloys, copper, thermally conductive plastics, thermally conductive carbon fiber composites material, or steel. Reflector 130 is formed by stamping, roll forming, die-casting, extrusion, or other suitable manufacturing process. Reflector 130 assists in directing the light emitted from light strip 10. Reflector 130 includes a polished, mirror-like surface for reflecting or focusing light emitted from light strip 10.

A flange 132 is formed on each distal end of reflector 130. Flange 132 extends the entire length 134 of reflector 130. Flange 132 includes two mounting screw holes 136. Flange 132 connects to a curved portion 138 at an angle 139. Curved portion 138 extends from flange 132 to a flat portion 140. Flat portion 140 connects orthogonally to a light strip attach portion 142. Light strip attach portion 142 extends in the same direction as flange 132. Adjacent light strip attach portions 142 are connected by a flat portion 144. Flat portion 144 is planar and extends orthogonally from light strip attach portion 142 away from curved portion 138. Flat portion 144 is approximately parallel to flat portion 140. Flat portion 144 includes a first surface 147 and a second surface 149 opposite first surface 147. First surface 147 is oriented toward light strip attach portion 142. Curved portions 138, flat portions 140, and light strip attach portions 142 have a length equal to the entire length 134 of reflector 130. Flat portion 144 includes an indirect reflector attach groove 145. Indirect reflector attach groove 145 is formed along the two sides of flat portion 144 not connected to light strip attach portions 142. Indirect reflector attach groove 145 creates a portion of flat portion 144 that has a length less than the entire length 134 of reflector 130.

An opening 146 is formed in light strip attach portion 142. Opening 146 is rectangular in shape and has a footprint larger than the footprint of end caps 18, lens 12, and walls 42 of light strip 10. The footprint of opening 146 is smaller than the footprint of base plate 40. Opening 146 is configured to allow walls 42, lens 12, and end caps 18, but not base plate 40, through opening 146. Light strip securing tabs 148 are formed in light strip attach portion 142. Tabs 148 are adjacent to opening 146. Tabs 148 bend and engage ridged portion 50 of light strip base 16 to secure LED light strip 10 to reflector 130.

Reflector 130 includes a stepped mounting portion 150 on each end of flat portion 140. Stepped mounting portion 150 includes a riser portion 152 and a plateau portion 154. Riser portion 152 extends vertically from flat portion 140 in a direction opposite flat portion 144. Riser portion 152 connects to plateau portion 154. Plateau portion 154 is approximately parallel to flat portion 140. Plateau portion 154 includes a mounting screw hole 136. Stepped mounting portion 150 prevents mechanical interference between flat portion 140 and any uneven or protruding portions of a housing fixture ceiling.

FIG. 6b shows the completed assembly of LED lighting assembly 160. Two light strips 10 are disposed over reflector 130. Lens 12, walls 42, and end caps 18 are disposed through opening 146. Base plate 40 is disposed over flat portion 144. Base plate 40 is approximately parallel to and rests against a surface of light strip attach portion 142 opposite curved portion 138. A thermally conductive material such as thermal grease, a thermally conductive pad, or a thermal epoxy is deposited between base plate 40 and light strip attach portion 142 to enhance the thermal connection between light strip 10 and reflector 130. Heat from substrate 24 is transferred from base 16 to reflector 130. Reflector 130 provides additional surface area from which heat generated by light engine 14 is dissipated. Power supply 92, from FIG. 4c, is disposed over first surface 147 of flat portion 144. Electrical input 94 electrically couples power supply 92 to an electricity source. Connectors 96 of power supply 92 are electrically coupled to electrical leads 98 of light strips 10.

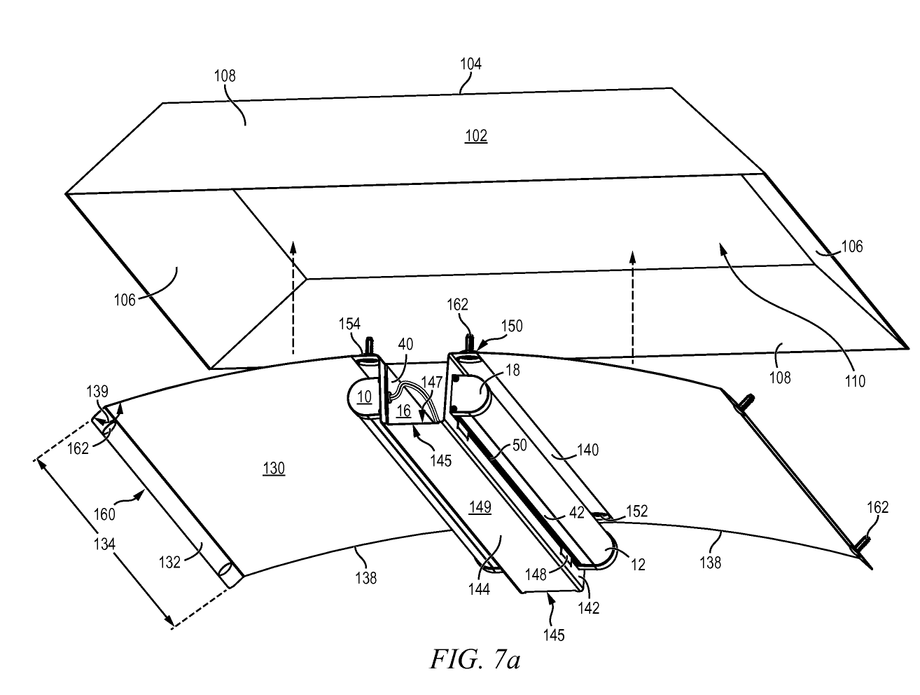

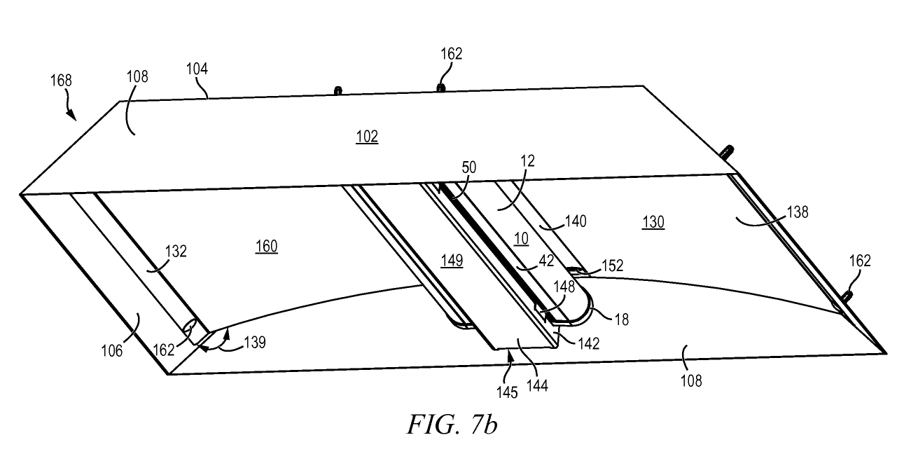

As shown in FIG. 7a, tabs 148 are disposed over ridged portion 50 on walls 42. Tabs 148 engage ridged portion 50 and secure light strip 10 to reflector 130. Reflector 130, light strips 10, and power supply 92 form LED lighting assembly 160. LED lighting assembly 160 is capable of retrofit into new or existing housing fixtures.

FIG. 7a shows housing 102 from FIG. 5a disposed over lighting assembly 160. Self-tapping screws 162 are disposed through screw holes 136 in flanges 132 and stepped mounting portions 150.

FIG. 7b shows lighting assembly 160 disposed within cavity 110 of housing 102. Screws 162 secure flanges 132 to sidewalls 106 and stepped mounting portions 150 to ceiling portion 104. Flat portion 140 is approximately parallel to ceiling portion 104. Angle 139, between flange 132 and curved portion 138 is adjusted such that flanges 132 rest against sidewalls 106. The length 134 of reflector 130 is approximately equal to the length of sidewalls 106. Thus, there is no space between curved portions 138, flat portions 140, and light strip attach portions 142 of reflector 130 and lateral walls 108. Indirect reflector attach groove 145 creates a small space between the ends of flat portion 144 and lateral walls 108.

The riser portion 152 of stepped mounting portion 150 creates a space between ceiling 104 and flat portion 140. The space created by riser portions 152 prevents mechanical interference between flat portion 140 and any random protrusions in ceiling 104 which extend into cavity 110. Lighting assembly 160 attached to housing 102 forms retrofitted lighting assembly 168.

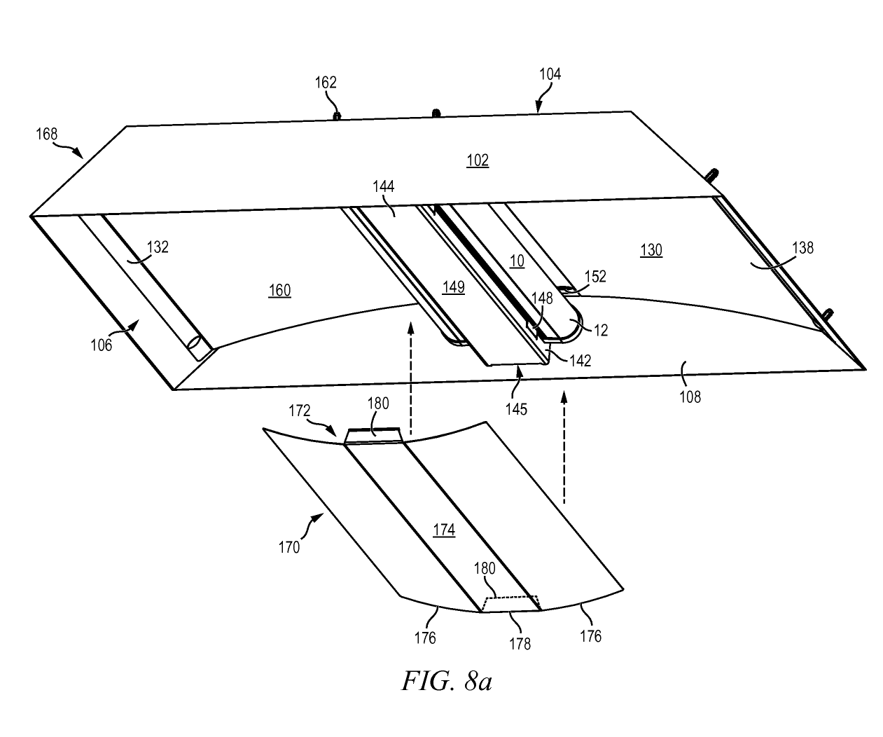

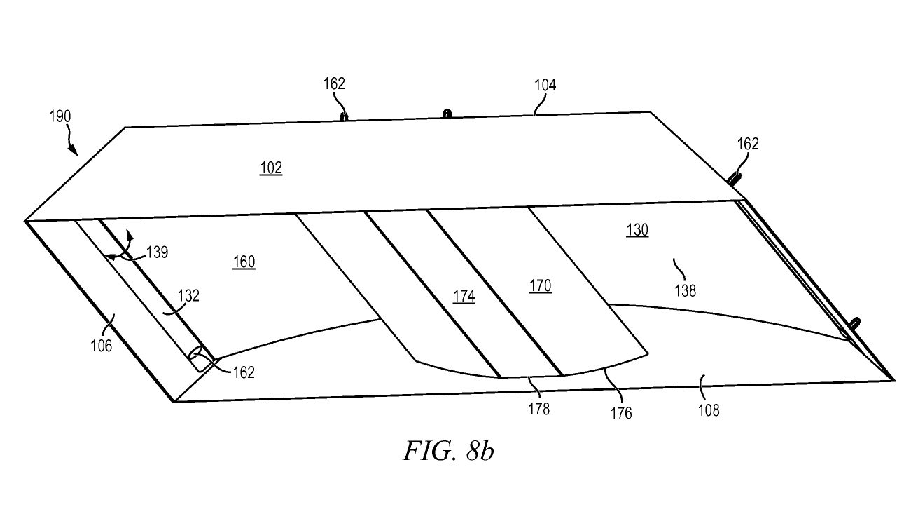

FIG. 8a shows attaching an indirect reflector 170 to retrofitted lighting assembly 168. Indirect reflector 170 assists in directing the light emitted from light strips 10. Indirect reflector 170 includes a polished, mirror-like surface for reflecting or focusing light emitted by light strip 10. In one embodiment, indirect reflector 170 is translucent or frosty and includes one or more light diffusing agents to filter the light emitted by light strip 10, including light emitted by light strip 10 that has been reflected by reflector 130.

Indirect reflector 170 includes a thermally conductive material such as aluminum, thermally conductive plastics, or thermally conductive carbon fiber composite material. Indirect reflector 170 is formed by molding, stamping, roll forming, die-casting, extrusion, or other suitable manufacturing process.

Indirect reflector 170 includes a first surface 172 and a second surface 174 opposite first surface 172. First surface 172 is oriented toward retrofitted LED lighting assembly 168. Indirect reflector 170 includes two curved portions 176 and a flat portion 178. Curved portions 176 are connected by flat portion 178. A flange 180 is formed on each of the two ends of flat portion 178 not connected to curved portions 176. Flange 180 extends vertically from flat portion 178. Flange 180 extends away from first surface 172 toward retrofitted lighting assembly 168. Flange 180 has a width approximately equal to the width of indirect reflector attach groove 145. Flanges 180 are aligned over the space between flat portion 144 and lateral walls 108.

FIG. 8b shows indirect reflector 170 attached to LED lighting assembly 160. Indirect reflector 170 is disposed over second surface 149 of reflector 130. Flat portion 178 of indirect reflector 170 is approximately parallel ceiling 104. Indirect reflector 170 has a length approximately equal to the length of sidewalls 106 of housing 102. Thus, there is no space between indirect reflector 170 and lateral walls 108. Flanges 180 of indirect reflector 170 are inserted between lateral walls 108 and flat portion 144. Indirect reflector 170 is secured by friction coupling between lateral walls 108, flanges 180, and flat portions 144. Indirect reflector 170 may also be attached with self-tapping screws, adhesive, or any other suitable fastener. A thermally conductive material such as thermal grease or thermal adhesive is deposited between flange 180 and lateral wall 108 to enhance the thermal connection between indirect reflector 170 and housing 102. In one embodiment, indirect reflector 170 is attached to lighting assembly 160 prior to disposing lighting assembly 160 within housing 102.

Indirect reflector 170, LED lighting assembly 160, and housing 102 form a retrofitted indirect LED lighting assembly 190. Indirect LED lighting assembly 190 provides a bright, energy efficient indirect lighting source with maximum luminous efficacy. Reflector 130, indirect reflector 170, and lens 12 disperse the light emitted from light strips 10 to provide a smooth, even light suitable for lighting an area in home, office, or commercial settings. Light strip base 16 and reflector 130 dissipate the heat generated by LEDs 26, prolonging the operating life and minimizing CCT shift of light engine 14.

While one or more embodiments of the present invention have been illustrated in detail, the skilled artisan will appreciate that modifications and adaptations to the embodiments may be made without departing from the scope of the present invention as set forth in the following claims.

What is claimed:

1. A method of making a lighting assembly, comprising:
providing a light strip by,
(a) forming a base including a ridged wall,
(b) disposing a light engine including a plurality of light-emitting diodes (LEDs) over the base, and
(c) disposing a lens over the light engine;
providing a first reflector including an opening and a tab adjacent to the opening;
disposing the light strip over the first reflector including the ridged wall disposed through the opening;
disposing the tab over the ridged wall to secure the light strip to the first reflector; and
disposing a power supply over the first reflector electrically coupled to the light strip.

2. The method of claim 1, further including forming the base of the light strip including a thermally conductive material.

3. The method of claim 1, further including forming the lens including a light-diffusing material.

4. The method of claim 1, further including disposing a second reflector over the first reflector.

5. The method of claim 1, further including disposing a housing fixture over the lighting assembly.

6. The method of claim 1, wherein the first reflector includes a stepped mounting portion.

7. A method of making a lighting assembly, comprising:
forming a base including a wall extending vertically from a base plate;
disposing a light engine including a plurality of light-emitting diodes (LEDs) over the base;
disposing a lens over the light engine;
providing a first reflector including an opening; and
disposing the base over the first reflector including the wall disposed through the opening.

8. The method of claim 7, further including disposing a second reflector over the first reflector.

9. The method of claim 7, further including forming the base by extrusion.

10. The method of claim 7, further including:
forming the wall of the base including a ridged portion; and
disposing a tab of the first reflector over the ridged portion of the wall.

11. The method of claim 7, further including disposing a coating over the lens.

12. The method of claim 7, further including attaching the lens to the base by expansion coupling.

13. The method of claim 7, wherein the first reflector includes a stepped mounting portion.

14. A lighting assembly, comprising:
a light strip including a base, a plurality of light-emitting diodes (LEDs) disposed over the base, and a lens disposed over the LEDs; and
a first reflector including an opening disposed over the light strip with a portion of the base of the light strip disposed through the opening.

15. The lighting assembly of claim 14, wherein the base of the light strip includes a wall extending from a base plate.

16. The lighting assembly of claim 15, further including:
a ridged portion of the wall disposed through the opening; and
a tab of the first reflector disposed over the ridged portion of the wall.

17. The lighting assembly of claim 14, further including:
a power supply electrically coupled to the light strip and disposed over the first reflector; and
a housing fixture disposed over the lighting assembly.

18. The lighting assembly of claim 14, further including a second reflector disposed over the first reflector.

19. The lighting assembly of claim 14, wherein the first reflector includes a stepped mounting portion.

20. A lighting assembly, comprising:
a first reflector; and
a light strip disposed over the first reflector and extending through an opening of the first reflector.

21. The lighting assembly of claim 20, further including a second reflector disposed over the first reflector.

22. The lighting assembly of claim 20, wherein the light strip includes:
a base; and
a light engine including a plurality of light-emitting diodes (LEDs) disposed over the base.

23. The lighting assembly of claim 22, further including a tab of the first reflector disposed over a ridged portion of the base.

24. The lighting assembly of claim 22, further including a lens including a light-diffusing material disposed over the light engine.

25. The lighting assembly of claim 20, wherein the first reflector includes a stepped mounting portion.
